(19) United States
(12) Patent Application Publication
(10) Pub. No.: US 2016/0004697 A1
(43) Pub. Date: Jan. 7, 2016

(54) Bilingual Search Engine for Mobile Devices

(71) Applicant: Maurice H.P.M. van Putten, Cambridge, MA (US)

(72) Inventor: Maurice H.P.M. van Putten, Cambridge, MA (US)

(21) Appl. No.: 14/324,155

(22) Filed: Jul. 5, 2014

(51) Int. Cl. G06F 17/30; G06F 17/28

(52) U.S. Cl. CPC G06F 17/3053; G06F 17/30864; G06F 17/289

(57) ABSTRACT

We disclose a method for a bilingual search engine producing a top list of concordances ranked by information content, controlled by a query of key words extended with parameters specifying the length of the concordances, the depth of the Internet search and a language of choice for a computer-generated translation of the results. Concordances are ranked by Shannon information using the method of van Putten, U.S. 2013/0191365 and accompanied by images extracted from the originating web pages. The method is particularly useful in creating universal access to the mostly English information on the World Wide Web.

### FIELD OF INVENTION

This invention relates generally to techniques for extracting information from large digital data bases by key word queries. Specifically, it relates to extracting concise text and image information in the form of concordances, ranked by Shannon information using the method of van Putten, U.S. 2013/0191365, and associated images, where the concordances are presented in two languages. The first language is the language of the originating document, and the second language is a language of choice by the reader.

### BACKGROUND OF THE INVENTION

Given the continuing exponential growth of the World Wide Web (WWW) and the migration of user access through mobile devices, Internet search engines are facing the challenge of effectively presenting concise information on relatively small screens. Furthermore, most of the web pages on the WWW are in English, while the population at large is mostly non-native English speaking.

Search on mobile devices requires the presentation of information “most probably” relevant in relatively few words. It requires extracting snippets of information from web pages containing a query of key words and presenting a subset of these to the user.

Currently, the probability of relevance of snippets of text is largely determined by a ranking of source documents, more precisely, source web pages by page ranking such as computed by the algorithm of Page, U.S. Pat. No. 6,285,999 (2001). However, of immediate relevance to a user is the information content of snippets themselves, much more so than the probable relevance of source web pages. Given a query of key words, a recent calculation shows the absence of any correlation between the Shannon information of concordances and page ranking of their source web pages (van Putten, U.S. 2013/019365 (2013)). It implies that page ranking cannot be used to rank snippets, and that informative snippets may be found across a fairly large number of pages, well beyond those listed on the first page shown by existing Internet search engines. For instance, informative snippets may be found in the first one hundred pages, well beyond the first ten typically shown on the first page of a Google search. However, a human search for informative snippets through one hundred pages is unrealistic, and even a human reading through the first ten is essentially impractical.

Identifying concise information suitable for mobile devices, therefore, requires novel information processing beyond and on top of document search performed by existing Internet search engines. To be precise, it requires a computer-generated extraction of concordances from source web pages identified by an existing Internet search engine, ranking of these concordances according to their information content, and presenting a top ranked list thereof to the user.

A method for calculating the information content of snippets is disclosed in van Putten, U.S. 2013/0191365. It enables objective ranking of snippets containing a query of key words, that is, concordances, based on Shannon information theory.

The length l_{c} of concordances is set by the number of words therein. The depth nₚ of an Internet search is set by the number of source web pages to be downloaded and analyzed. Both this length and depth are user-defined parameters accompanying a query of key words. For example, the query

apple pie/40 80 (1)

defines a search for concordances of l_{c}=40 words in length extracted from nₚ=80 web pages, retrieved from the WWW. Concordances of 50 words containing the key words apple and pie are extracted from 80 pages, and ranked according to their information content by Shannon information theory based on word frequencies of the natural language. Presented to the user is a top list of ranked concordances, e.g., the first ten, to create a highly focused output of essentially maximal information, suitable for relatively small screens of mobile devices.

To bridge the language barrier posed by English as the de facto language of the WWW to the non-native English population at large, we here disclose a novel method for bilingual search, producing output in a user's native language alongside output extracted from English source pages. The method takes advantage of the concise search results in concordances enabling essentially instantaneous computer-generated translation into a second language. Translations of entire source web pages dedicated to each individual search query are not practical or realizable giving limited computing resources. In contrast, translations of a top list of concordances is computable on a time scale of seconds.

A search engine offering an automatic bilingual computer-generated output in concordances renders the WWW universally accessible regardless to the world-wide population at large, irrespective of native language.

Combining a bilingual output in concordances ranked by information content accompanied by images, a completely novel synergy is realized of otherwise separate channels of information. This synergy radically surpasses existing art, using any of the existing Internet search engines and online translation services, comprising the separate and typically time-consuming actions of performing (1) a document search, (2) a human identification of one or more relevant passages, (3) online translation by copy-and-paste of such passage(s) and, possibly, a further (4) image search on the same topic.

The fully automated synergy in the present disclosure is uniquely possible on the basis of a selected few, top ranked concordances, allowing for relatively fast and low cost computer-generated translations.

### OBJECTS AND SUMMARY OF THE DISCLOSURE

It is an object of the present invention to create a universal appeal to searching the WWW regardless of the user's native language and to optimize the user's experience in the interpretation of search results, in condensed form suitable for mobile devices.

To this end, two novel features are disclosed. A top list of concordances is accompanied by computer-generated translations in a language of choice alongside images extracted from their source web pages. A specific objective is to surpass the existing art in searching for relevant text, translations and images comprising a document search using an Internet search engine, reading documents for identification of pertinent passages, copy-and-paste thereof to online translation services and, if so desired, searches for related images.

To accomplish these and other objectives, the present invention builds on van Putten, U.S. 2013/0191365, which enables the extraction of concise information in the form of concordances ranked by information content. A key objective of the present disclosure is a seamless synergy of a bilingual output of a top list of ranked concordances accompanied by relevant images with no overhead other than a specification of the user's choice of preferred output language.

For a bilingual search engine, we extend (1) with an additional parameter specifying the user's choice of preferred language. A French person visiting abroad, for instance, may choose to read search results in her/his native language by adding fr, i.e.,

apple pie/40 80 fr. (2)

For results obtained from English web pages by default, the parameter fr forces the search engine to produce accompanying translations French.

To further direct attention in the interpretation of search results, the output concordances are shown with accompanying images. Most but not all web pages contain one or several images illustrating their content. Most commonly, these images are in jpeg format, representing the Join Photographic Experts Group standard of image compression. Adding one of these jpeg images from a web page provides with high probability a relevant illustration to a concordance extracted from the same page.

### SURVEY OF THE DRAWINGS AND EXAMPLES

FIG. 1 shows the bilingual output produced by the extended query (2) with accompanying images extracted from the respective source web pages, here shown on a FireFox browser. The output is extracted from 80 source web pages, from hyperlinks provided on the first 8 pages of a Google search, followed by identification and ranking of concordances of 40 words containing the key words apple and pie, and embedding the top ten thereof in HTML for presentation in an Internet browser. The results shown include hyperlinks to images in the associated source web pages, the numerical rank of the concordance, defined by the average information per word calculated by the method of van Putten U.S. 2013/0191365, here 3.013179, 2.906195, 2.884091, 2.808034, . . . , and the computer-generated translation in French. The result is a synergy of bilingual text and image output for a concise presentation of information suitable for a mobile device.

FIG. 2 shows bilingual text and image output to the extended queries “mango fruit/25 80 fr” (left panel) and “mango fruit/25 80 ko” (right panel) on an iPhone 5. Here, 25 word concordances are used for a presentation suitable for the relatively small screen size.

### PREFERRED EMBODIMENTS

In a preferred embodiment, the search engine runs as a dedicated software application on the user's device. The application provides the user-interface to an underlying text based browser, that serves as an agent in the communication to one or more existing Internet search engines. Following a user-defined query of key words, it obtains a list of hyperlinks to potentially relevant source web pages. An extended key word query such as (2) includes the number n, of source web pages, defining the depth of the Internet search, e.g., nₚ=80 in (2). The text based browser subsequently downloads nₚ source web pages specified by these source web pages. The same application subsequently produces a ranked list of concordances of given length l_{c}, specified in an extended key word query such as (2), by the method of van Putten, U.S. 2013/0191365, e.g., l_{c}=50 in (2). The application thus produces a top list of concordances for final presentation to the user.

Following the objective of present disclosure, the application subsequently produces computer-generated translations of the top list of concordances in a choice of second language, and augments these with images extracted from the respective source web pages, if available. In case of multiple high ranked concordances from the same source web page, images accompanying each are extracted in sequence of occurrence from the originating source web pages. Experiments show this produces satisfactory results.

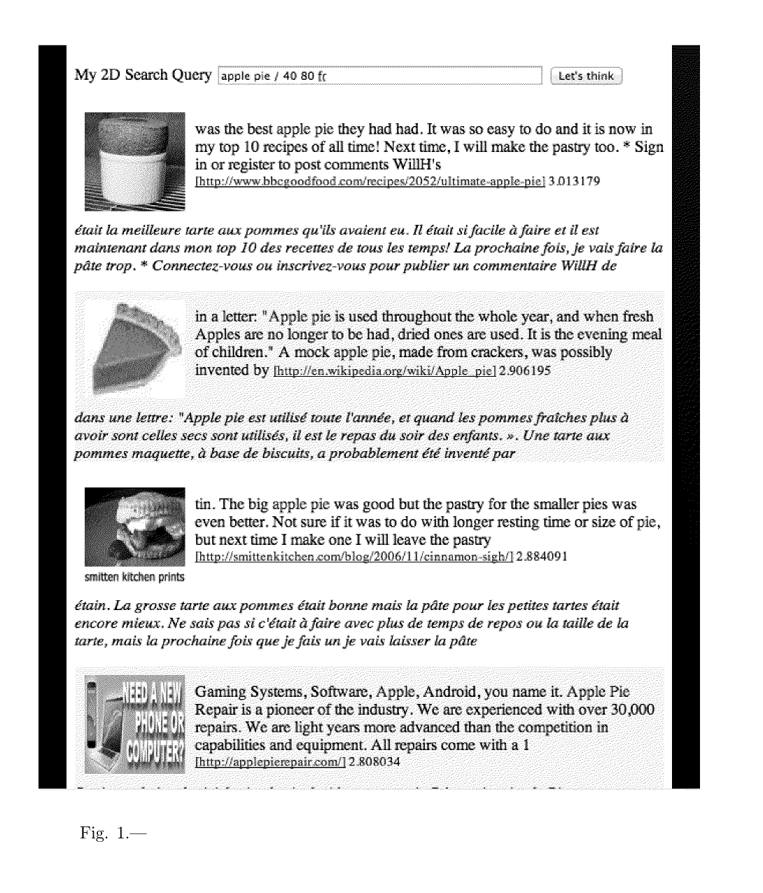

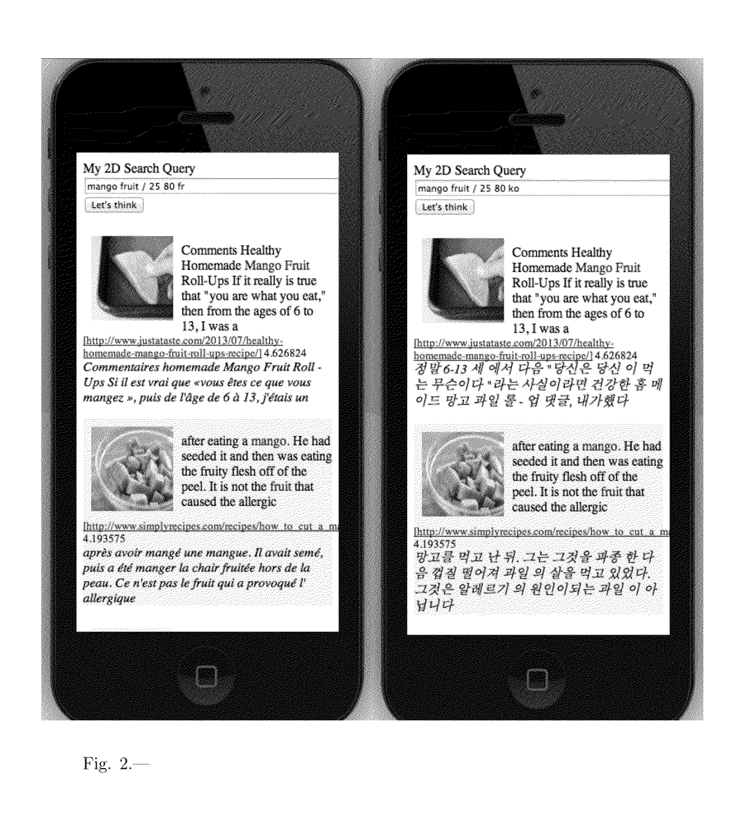

In an alternative preferred embodiment, the search engine runs as a software-as-a-service (SaaS) on a remote server, accessed through an Internet browser such as Chrome, FireFox or Internet Explorer, used in the creation of FIGS. 1-3 in the present disclosure.

### DETAILED DESCRIPTION

The computer implementation of a method for a bilingual search engine facilitating universal access by a user's choice of second language, comprising various steps in respond to the extended query of the form

K/P, (3)

where K={k₁, k₂, . . . kₘ} represents m key words and P={l_{c}, nₚ, lang} represents parameters specifying the length l_{c} of the output concordances in terms of the number of words, the depth nₚ of the search in terms of the number of source web pages and the language of choice lang.

In what follows, we shall use the following definitions:
An Internet search engine shall refer to any of the existing search engines which, in response to a query of key words, produce a ranked list of web pages. Their ranking represents the relevance of web pages as documents within the WWW, defined by their hyperlinks. Examples of existing Internet search engines are Google of Google.com, Bing of Microsoft.com or DuckDuckGo of DuckDuckGo.com;
HTML is the HyperText Markup Language of web pages for interpretation by Internet browsers such as Chrome of Google.com, FireFox of FireFox.org or Internet Explorer of Microsoft.com. HTML is expressed in tags, enabling the specification of hyperlinks to other web pages, hyperlinks to images, the title of a web pages, and text edits such as boldface, and so on;

In this disclosure, source hyperlinks are hyperlinks to web pages identified by an Internet search engine in response to a given query of key words;

In this disclosure, source web pages are the web pages related to a given query of key words;

In this disclosure, source image hyperlinks are image hyperlinks embedded in source web pages.

Following the extended key word query (3), the computer processing the method disclosed herein first responds with the steps disclosed in van Putten, U.S. 2013/0192365, comprising:
1. Identifying nₚ web pages by sending query key words K={k₁, k₂, . . . kₘ} to an existing Internet search engine and extracting a list of up to n, hyperlinks to source web pages from its output;
2. Downloading all source web pages identified by the hyperlinks of the previous step. The result is a body of up to nₚ source web pages of source text on the computer;
3. Extracting from each of the downloaded source web pages the title, hyperlinks to images and. concordances of length l_{c} containing the query key words {k₁, k₂, . . . kₘ};
4. Ranking of the concordances thus obtained, preserving their associated page title and hyperlinks to images, where ranking is by Shannon information;
5. Extracting a list of top ranked concordances, limited in number for presentation on mobile devices.

Following these steps, the computer subsequently creates a user-friendly output adapted to a choice of language specified by lang in (3), comprising:
1. Translating each concordance in the language lang specified in (3);
2. Creating an output page showing concordances and their translations, including an image or hyperlink thereto from the corresponding source web page and the original hyperlink that may further include the title of the latter.
3. Presenting the resulting bilingual text-and-image output to the user, directly to a screen when run as an application on the user's device or indirectly after embedding in HTML to an Internet browser running on the user's device.

### BRIEF SUMMARY OF THE INVENTION

The World Wide Web shows a continuing exponential growth of information. While it is mostly written in English, the majority of the world's population is a non-native English speaker. In the present migration to mobile devices with limited screen size, Internet Search Engines are facing the challenge of effective dissemination of information to users world-wide. To meet these challenges, we disclose a bilingual search engine which presents English concordances containing a query of key words, ranked by Shannon information using the method of van Putten, U.S. 2013/0191365, along with computer-generated translations in a choice of language. In the preferred embodiment, concordances are accompanied by images extracted from the originating web pages. Examples are given for searches in English along with their translations in French, Dutch, Chinese and Korean, to illustrate the viability of our approach and the power of computing to effectively ameliorate language barriers in Internet search.

What we claim is:

1. A computer implemented method for a bilingual search engine facilitating universal access to information on the World Wide Web in response to a query of key words extended with parameters, where said parameters include the length of concordances in terms of the number of words l_{c}, the depth of the Internet search in terms of the number of source web pages nₚ to be downloaded and analyzed and a choice of second language lang, comprising:
(a) obtaining a list of nₚ hyperlinks to source web pages by submitting a query of key words to an existing Internet search engine;
(b) downloading n, source web pages obtained in Step (a);
(c) extracting concordances from the nₚ source web pages downloaded in Step (b), each containing said query of key words in snippets of l_{c} words identified in said source web pages;
(d) ranking of said concordances in Step (c) according to information content by application of Shannon information theory;
(e) extracting a top list of concordances of highest rank for presentation to the user;
with the property that the method processes each of said top list of concordances in Step (e) by
(f) translating each concordance in a second language lang, if different from its corresponding source web page;
(g) augmenting each concordance with an image or hyperlink to an image extracted from its source web page;
(h) augmenting each concordance and image combination with a hyperlinks to their source web page;
(i) presenting the combined bilingual text and image output of Step (h) to the user.

2. A computer implemented method for a bilingual search engine facilitating universal access described in claim 1 with the property that said method is run from the user's device such as a PC, tablet or mobile phone.

3. A computer implemented method for a bilingual search engine facilitating universal access described in claim 1 with the property that said method operated by the user through a web browser, where said method is running on a remote server as a software-as-a-service.
